(19) United States
(12) Patent Application Publication
(10) Pub. No.: US 2020/0171766 A1
(43) Pub. Date: Jun. 4, 2020

(54) METHOD AND DEVICE FOR PRODUCING TIRES

(71) Applicant: HARBURG-FREUDENBERGER MASCHINENBAU GMBH, Hamburg (DE)

(72) Inventors: Markus WACHTER, Ahrensburg (DE); Achim BEHRENS, Asendorf (DE); Thomas LANGE-KRAUEL, Hamburg (DE)

(21) Appl. No.: 16/621,145

(22) PCT Filed: May 11, 2018
(86) PCT No.: PCT/DE2018/000144

§ 371 Date: Dec. 10, 2019

(30) Foreign Application Priority Data
Jun. 16, 2017 (DE) 10 2017 005 832.6

(51) Int. Cl. B29D 30/26; B29D 30/32

(52) U.S. Cl. CPC B29D 30/26; B29D 30/32; B29D 2030/3207; B29D 2030/3214; B29D 2030/2664

(57) ABSTRACT

A method and a device for producing a tire blank. At least two strip-shaped materials are positioned on a tire building drum. At least two cores are set in place. The tire building drum has a core clamping element and a core fixing element. The core fixing is forcibly guided by a lever. The tire building drum includes a middle part and two drum halves arranged on both sides of the middle part so as to be positionable axially. The middle part is provided in a radial direction with a variable diameter. A radial diametral enlargement of the middle part is executed prior to the cores being set in place. The middle parts can be covered on the outside with a center sleeve of stretchable material. Furthermore, the middle parts can be contoured so that reinforcing strip pockets, which promote the production of tires with reinforced side walls, are formed.

The invention relates to a method for producing a tire blank, in which at least two strip-shaped materials are positioned on a tire building drum and in which at least two cores are set in place.

The invention additionally relates to a device for producing a tire blank, in which at least two strip-shaped materials can be positioned on a tire drum and in which at least two cores can be positioned.

In the production of tire blanks, strip-shaped materials are positioned on a tire building drum. Into the elastomeric materials are often laid threadlike materials (casing threads) for reinforcement purposes. In lateral regions, a core is respectively set in place for reinforcement purposes.

According to the known prior art, the material which is used is placed onto a device consisting of middle and side parts. Cores which are used are positioned and clamped from inside. The inner side of the cores is supported by a shoulder, and the core clamping remains active throughout the process. As a result of this permanent core clamping, a ply turn-up is possible only in the upward direction.

A further drawback of the prior art consists in the fact that a thread length between the cores is not clearly defined. In addition, there is no possibility of working the material under the core.

To date, the accuracy requirements in the positioning of the cores cannot yet be achieved in a fully satisfactory manner.

The object of the present invention is to improve a method of the type stated in the introduction such that the positioning accuracy is increased.

This object is achieved according to the invention by virtue of the fact that the tire building drum is provided both with a core clamping element and with a core fixing element.

A further object of the invention is to design a device of the type stated in the introduction such that an increased positioning accuracy is achieved.

This object is achieved according to the invention by virtue of the fact that the tire building drum is provided both with a core clamping element and with a core fixing element.

According to the invention, it is in particular provided that the tire building drum is formed of a middle part and two drum halves arranged on both sides next to the middle part, that the drum halves are positionable in an axial direction, that the middle part is provided in a radial direction with a variable diameter, and that a radial diametral enlargement of the middle part is performed prior to insertion of the cores.

In particular, it is envisioned that the two drum halves are movable independently of each other. The positioning can be executed using at least one servo motor.

Prior to the insertion of the cores, the middle part is expanded in a radial direction and the strip-shaped material on the tire building drum is hereby tensioned. As a result, a linear stretching of the casing threads is achieved, which results in a constant thread length, clamped between the cores, in the casing. After this, the core setters can press the cores against the side flanks of the expanded middle part in order to fix them there.

The method according to the invention makes it possible, in particular, to provide very uniform thread lengths between the cores. This promotes a round configuration of the tires and a uniform material distribution.

The mutually independent positionability of the drum halves makes it possible, in a single-stage design, to travel between the side parts and the middle part with the aid of pressure devices. The tire blank can hereby be molded in the side wall region without the need to switch to another drum.

In the accompanying figures, the method steps according to the invention and the device according to the invention are explained further. In the used abbreviations, “IL” denotes Inner Liner, and thus the inner strip material, while “BP” denotes Body Ply, and thus the body material.

According to the invention, a generally known two-stage process is realized in a single-stage machine.

Through the combination of both a core clamping element and a core fixing element in the region of the tire building drum, a markedly improved repeat accuracy is achieved in the production of the tire.

The combination of the core clamping element and the core fixing element likewise makes it possible in a single-stage process to produce tires which are otherwise producible only in a two-stage process.

In particular, by virtue of the combination of features according to the invention, it is possible to drive a chosen material into the cores in a single-stage process.

In an advantageous embodiment of a tire building drum according to the invention, the core fixing segments are moved with the aid of at least one lever into the expand or collapse position. By virtue of this forced guidance, a synchronous, centric bead fixing is ensured.

In methods according to the prior art, the problem has hitherto arisen that the cores are lost in the course of the cambering. According to the method according to the invention and using the device according to the invention, the cores are now held in the casing bond and are no longer lost.

Up till now, the person skilled in the art had assumed that a two-stage or multistage tire production is absolutely necessary. According to the invention, it has been recognized that a single-stage process execution is also possible. A basic notion according to the invention thus already in isolation consists in realizing a tire production process in one stage.

In particular, it should also be re-emphasized that a fundamental aspect according to the invention consists in the cores remaining constantly fixed throughout the single-stage building process.

In the drawings, illustrative embodiments of the invention are represented schematically, wherein

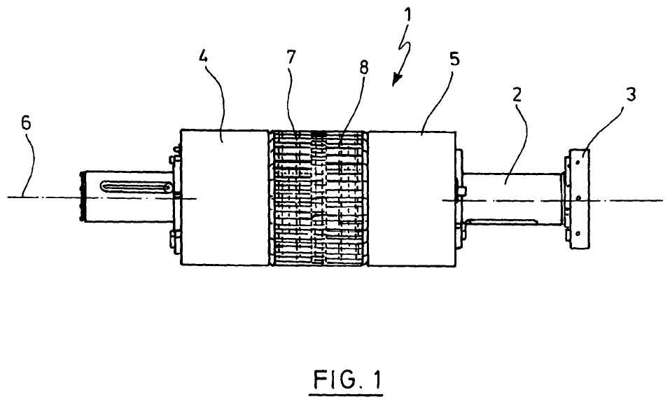

FIG. 1 shows a side view of a tire building drum, which is equipped with a core clamping element and a core fixing element,

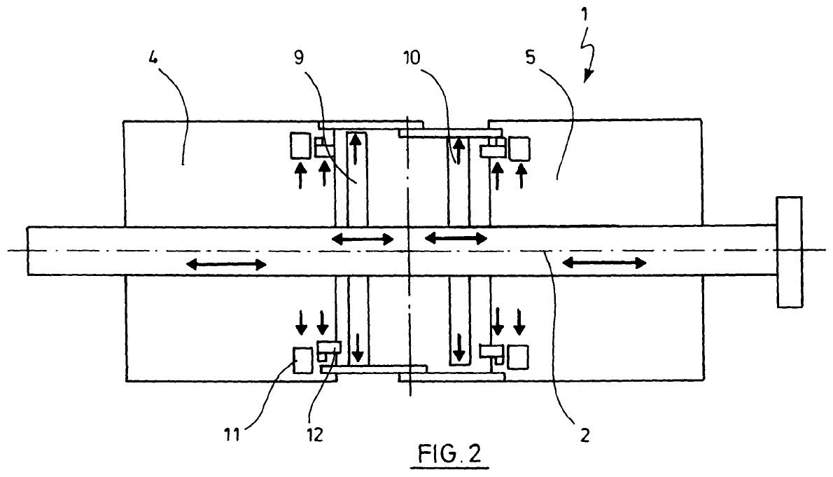

FIG. 2 shows a longitudinal section through the tire building drum according to FIG. 1,

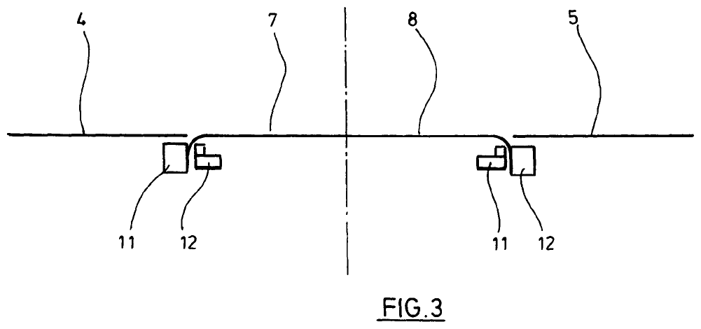

FIG. 3 shows a schematic representation of the drum in a flat state,

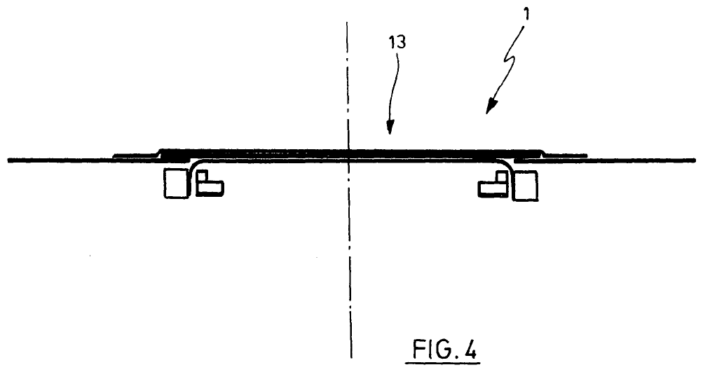

FIG. 4 shows the drum according to FIG. 3 in a flat state with applied material,

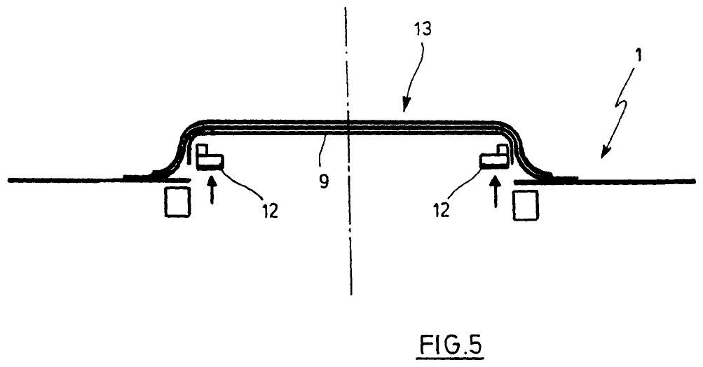

FIG. 5 shows the tire building drum with an expanded core fixing element and an outwardly displaced center device,

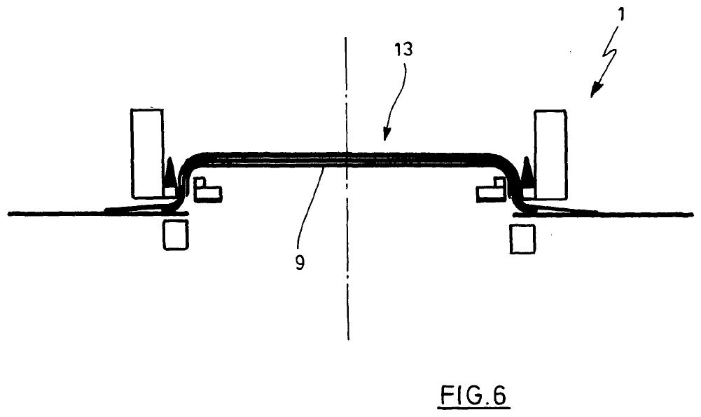

FIG. 6 shows the tire building drum with cores held from outside and cores set in place for the tightening of the material,

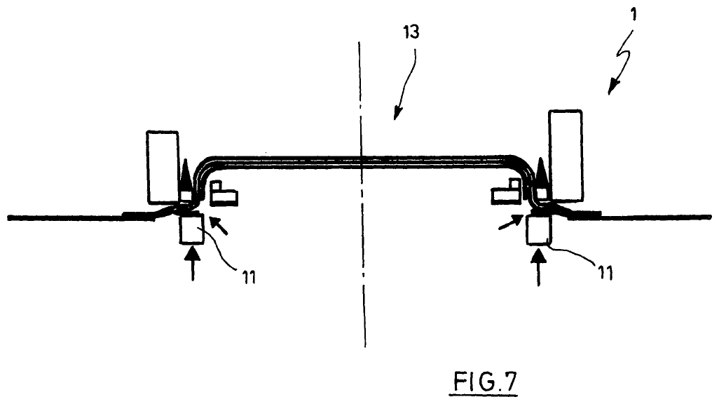

FIG. 7 shows the tire building drum with cores held from outside and set in place,

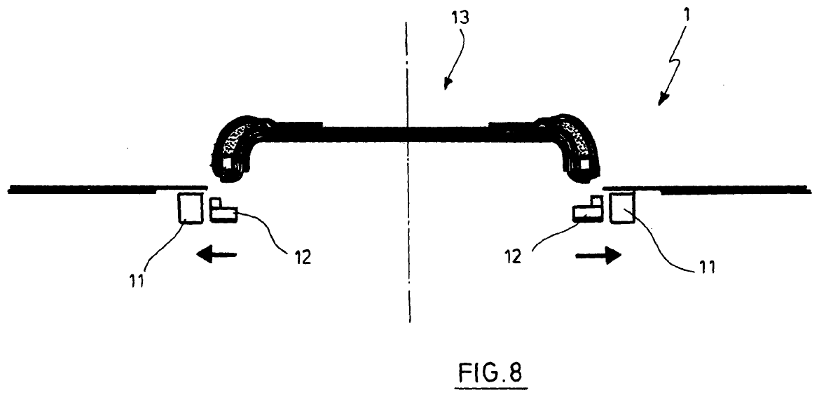

FIG. 8 shows the tire building drum after a completed ply turn-up and cores held on the middle part,

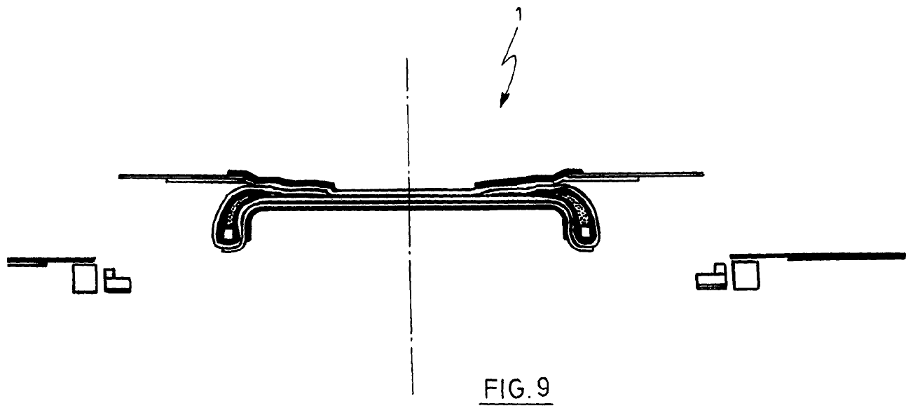

FIG. 9 shows the tire building drum with a material pack fixedly seated on the middle part,

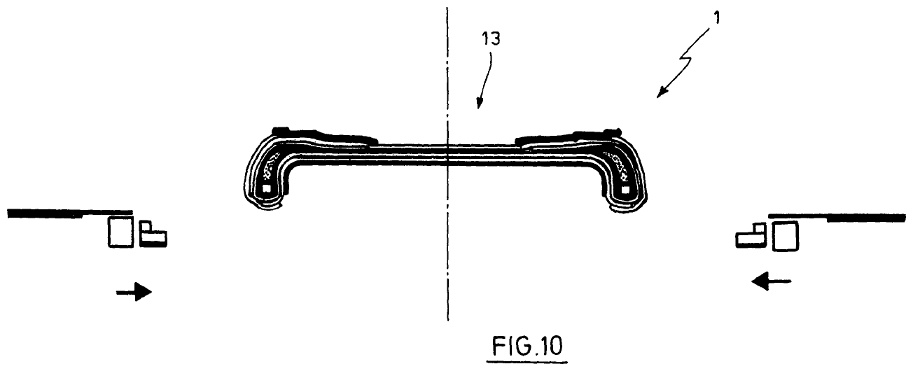

FIG. 10 shows the tire building drum after the material has been turned up to under the core,

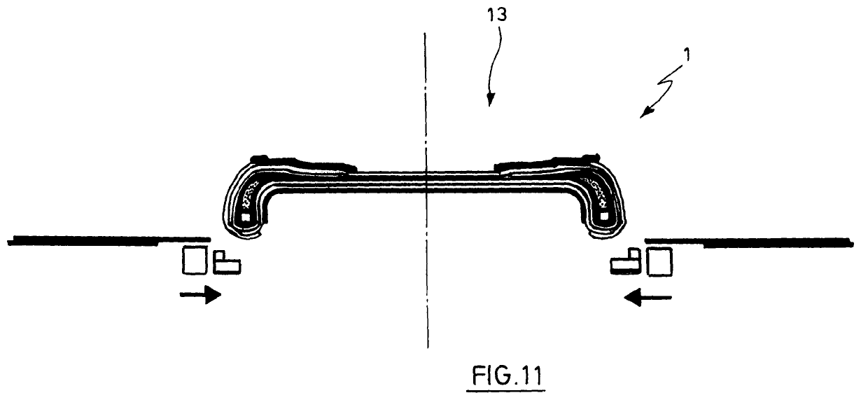

FIG. 11 shows the tire building drum with brought together drum halves,

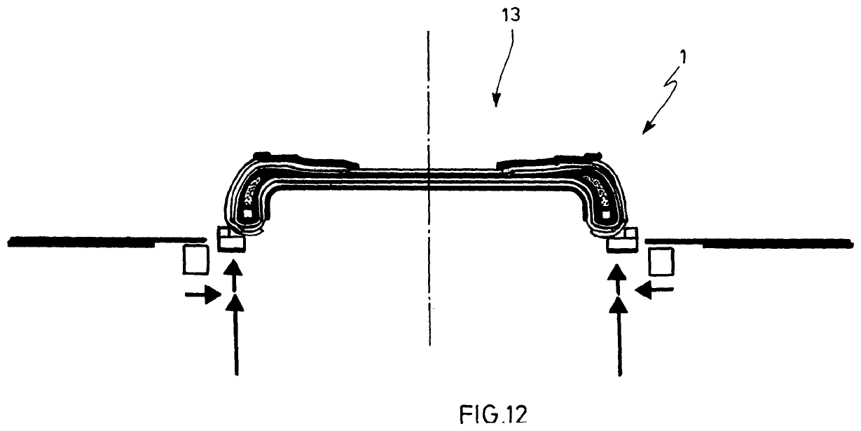

FIG. 12 shows the tire building drum in the case of a core fixing element expanded with little pressure, and

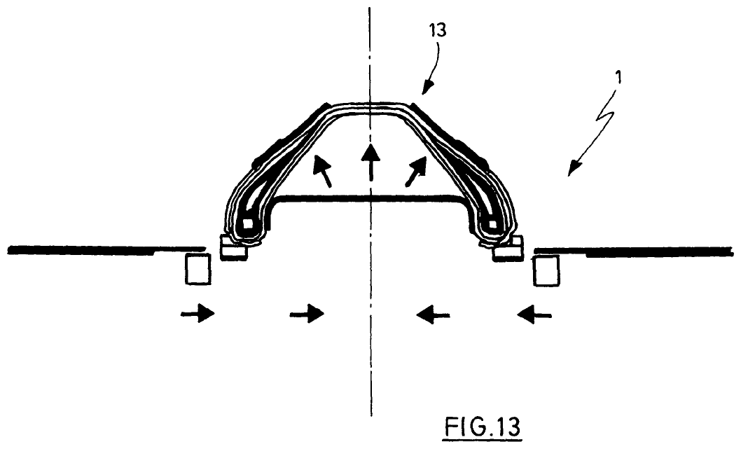

FIG. 13 shows the tire building drum with a completely fixed casing package, which is subjected to pressure and is raised toward the middle,

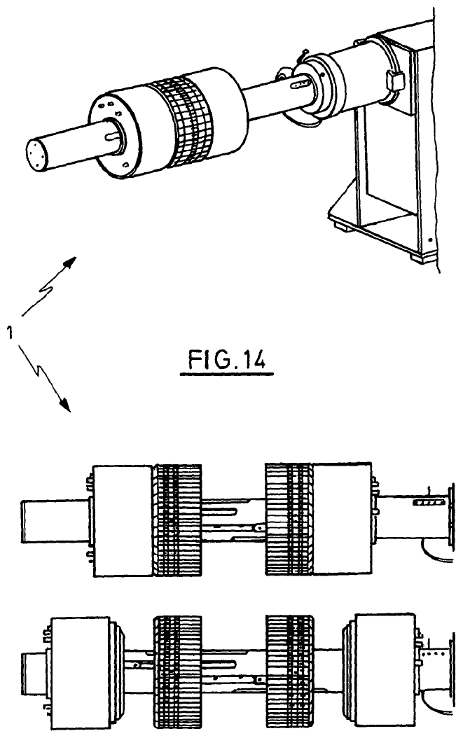

FIG. 14 shows a perspective view of a tire building drum according to the invention and two side views of tire building drums according to the invention,

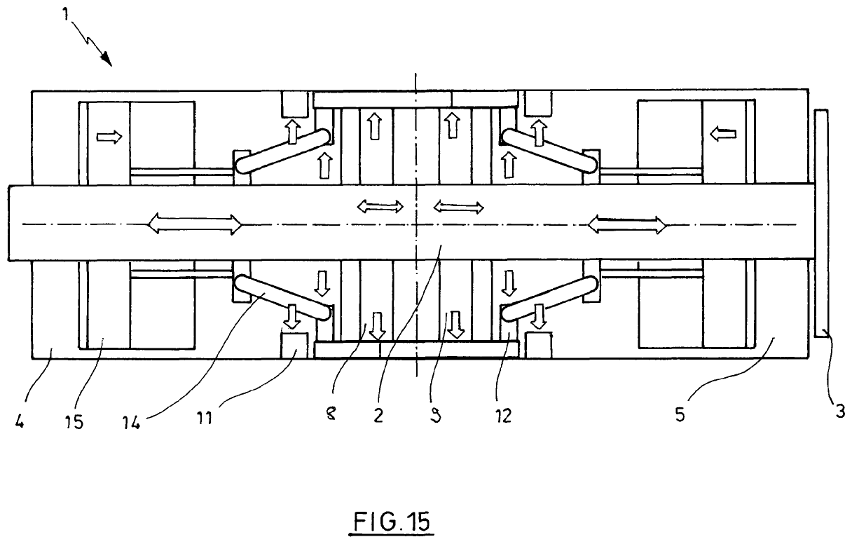

FIG. 15 shows a longitudinal section through a tire building drum according to the invention with forced guidance of the core fixing element,

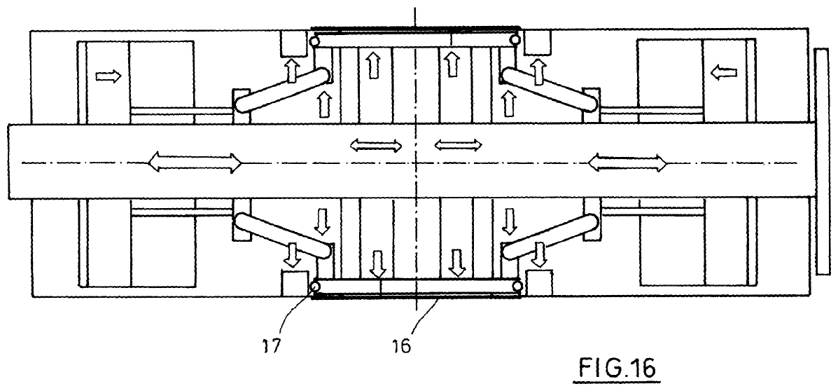

FIG. 16 shows a longitudinal section through a tire building drum according to the invention with forced guidance of the core fixing element and center sleeve,

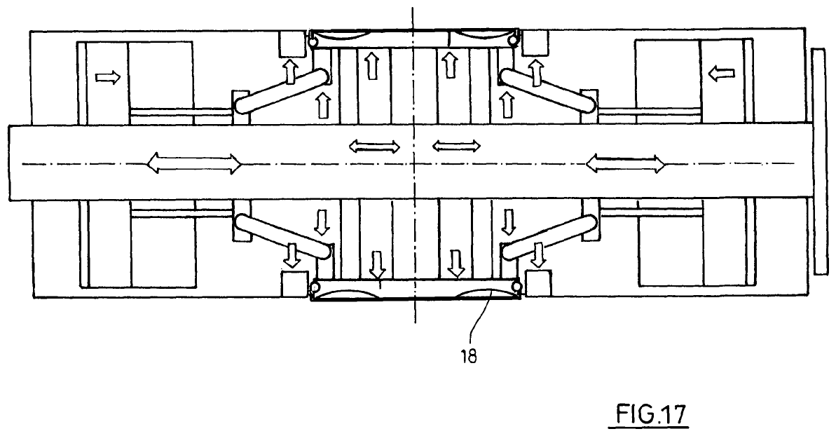

FIG. 17 shows a longitudinal section through a tire building drum according to the invention with forced guidance of the core fixing, center sleeve and reinforcing strip pockets,

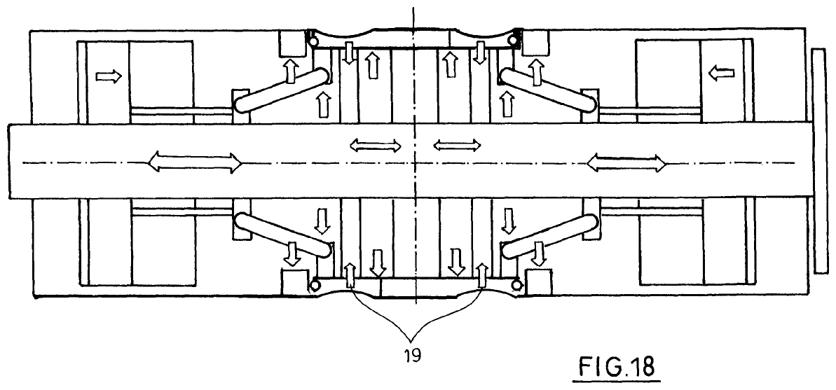

FIG. 18 shows a longitudinal section through the tire building drum shown in FIG. 17, with activated vacuum for the formation of reinforcing strip pockets.

FIG. 1 shows a tire building drum (1) for use as a device for producing a tire blank. The tire building drum (1) is fixed on a shaft (2). The shaft (2) is guided rotatably in the region of a bearing (3).

In a longitudinal direction (6) between the drum halves (4, 5) are arranged two middle parts (7, 8).

FIG. 2 shows a longitudinal section through the tire building drum (1) according to FIG. 1. It can be seen that the drum halves (4, 5) are arranged displaceably along the shaft (2). Between the drum halves (4, 5) are arranged center devices (9, 10). A core clamping element (11) and a core fixing element (12) can additionally be seen. Basically, the method process proceeds in accordance with the process steps described below. In a first step, the material is pretensioned by an extension of the center device (9, 10). After this, the cores are set laterally against the center device (9, 10) and clamped from inside. The material is hereupon tightened further, after which the material is turned up onto the center device (9, 10). In a final process step, the core clamping element (11) is released and the drum halves (4, 5) are moved outward.

Through the movement of the drum halves (4, 5), a clearance is formed between the center device (9, 10) and the drum halves (4, 5). Further material can then be applied. The material is then turned up to under the core with a stitcher.

In a next process step, the drum halves (4, 5) move to the center device (9, 10) and the core fixing element (12) is brought into position under the core.

As a result of the process steps of an initially slight expansion, then the bringing together, and subsequently the full expansion, in the interaction with the center device (9, 10) the core is fully fixed. A continuation of the process is realized to a necessary extent.

The individual process steps which have been described in compressed form above are described in detail below with reference to the further figures.

FIG. 3 shows the tire building drum (1) in a flat state. The drum halves (4, 5), the middle parts (7, 8), and the core clamping element (11) and the core fixing element (12) can be seen.

According to FIG. 4, the tire building drum (1) is still in the flat state. The material (13) is applied.

According to the process step represented in FIG. 5, the core fixing element (12) is expanded and hereupon lifts the center device (9) outward. The material (13) is hereby tightened.

According to the process steps represented in FIG. 6, the cores are defined by means of the device and are held from outside. The cores are set in place and the material is hereby tightened further. The core setting spacing or the distance from core to core is exactly predefined by the center device (9) and is thus more clearly defined than in processes according to the prior art.

According to the process step represented in FIG. 7, the cores are defined by means of the device and held from outside. The cores are set in place and the cores are clamped from below by the expanding core clamping element (11). A front part of a bellows is hereupon raised and hereby retightens the material (13).

According to the process step represented in FIG. 8, the ply turn-up is realized and the cores are set in place and held in a defined manner against the middle part. As a result of the material composite, the material package (13) is fixedly seated on the middle part. The core clamping element (11) is retracted, and the core fixing element (12) is likewise retracted. The drum halves (4, 5) can move apart.

According to the process step represented in FIG. 9, the cores are set in place and held in a defined manner against the middle part. As a result of the material composite, the material pack (13) is fixedly seated on the middle part. The two drum halves (4, 5) are parted. A clearance is hereby formed between the drum halves (4, 5) and the center device (9, 10). In a next step, the material is applied. According to the process step represented in FIG. 10, the material (13) is turned up to under the core and the two drum halves (4, 5) come together.

According to the process step represented in FIG. 11, the two drum halves (4, 5) come together and the core fixing element (12) is in position under the cores. According to the process step represented in FIG. 12, the core fixing element (12) expands with little pressure and the drum halves (4, 5) move in the direction of the drum middle in order to fix the core with the outer locating edge of the core fixing element (12). The core fixing element (12) then expands at high pressure in order to fully fix the core.

According to the process step represented in FIG. 13, the completely fixed casing package is subjected to pressure and is raised in the middle. Parallel to this process, the drum halves (4, 5) and the center device (9, 10) come together. As a result of the distance between the cores, which distance is defined at each point in the process, an excellent uniformity of the tires can be achieved. The fact that the core is supported throughout the process likewise contributes to this uniformity.

FIG. 14 shows, for clarification purposes, further views of the tire building drum (1) in different positionings of the individual parts.

According to that embodiment of a tire building drum (1) according to the invention that is shown in FIG. 15, the core fixing element (12) is forcibly guided by means of a lever (14). In the represented advantageous embodiment, the lever (14) is designed as a toggle lever and is driven with the aid of a thrust cylinder (15). However, other lever and drive forms are also conceivable. Depending on the relative positioning of middle part (7, 8) and drum halves (4, 5), the core fixing element (12) can be moved next to, or else under, the middle parts (7, 8) in the radial direction. In particular, also an expanded setting of the center device (9, 10) can thus be achieved with the aid of the core fixing element (12).

FIG. 16 shows an embodiment according to the invention of a tire building drum (1) having a center sleeve (16). The center sleeve (16) covers the middle parts (7, 8) and thus enables the middle parts (7, 8) to be designed as closed cylindrical bodies. In an advantageous embodiment, the center sleeve (16) consists of material which is stretchable both in the radial and in the axial direction. The center sleeve (16) is fixed in the outer region of the segmental fingers of the middle parts (7, 8) by means of a center sleeve frame (17).

In FIG. 17, an embodiment of a tires building drum (1) according to the invention is represented with reinforcing strip pockets (18). The reinforcing strip pockets (18) are formed by radially circumferential recesses in the middle parts (7, 8) and, in the represented embodiment, are outwardly bounded by a center sleeve (16). The purpose of the reinforcing strip pockets (18) is to promote by manufacturing technology the production of tires with reinforcing strips in the side wall region.

On the basis of the reinforcing strip contour, pockets (18) on the inboard and outboard sides are provided in the finger segments of the middle parts (7, 8).

FIG. 18 shows that embodiment of a tire building drum (1) according to the invention that is represented in FIG. 17. With the aid of a vacuum (19), the center sleeve (16) is sucked into the reinforcing strip pockets (18) applied in the finger segments of the middle parts (7, 8) and thus opens up the contour necessary for the introduction of reinforcing strips in a defined position. In particular, this is of importance for the production of tires with side wall reinforcement or with “run-on-flat” option. Since the reinforcing strips, thanks to the inventive contour of the middle parts (7, 8), lie in the reinforcing strip pockets (18), a substantially plane support surface is provided for a further strip.

1-20. (canceled)

21. A method for producing a tire blank, comprising the steps of; positioning at least two strip-shaped materials on a tire building drum; setting at least two cores in place; and providing the tire building drum both with a core clamping element and with a core fixing element.

22. The method according to claim 21, wherein the tire building drum is formed of a middle part and two drum halves arranged on both sides next to the middle part.

23. The method according to claim 22, wherein the drum halves are positionable in an axial direction.

24. The method according to claim 22, including providing the middle part with a variable diameter in a radial direction.

25. The method according to claim 24, including executing a radial diametral enlargement of the middle part prior to setting the cores in place.

26. A device for producing a tire blank, comprising: a tire building drum on which at least two strip-shaped materials are positionable, and in which at least two cores are settable in place; a core damping element provided in the tire building drum; and a core fixing element provided in the tire building drum.

27. The device according to claim 26, wherein the tire building drum is formed of a middle part and two drum halves arranged on both sides next to the middle part.

28. The device according to claim 27, wherein the drum halves are positionable in an axial direction.

29. The device according to claim 27, wherein the middle part has a variable diameter in a radial direction.

30. The device according to claim 29, wherein the middle part is radially diametrically enlargeable to execute a linear stretching of casing threads prior to the cores being set in place.

31. The device according to claim 28, wherein the drum halves are positionable independently of each other.

32. The device according to claim 26, further comprising at least one core setter positionable in an axial direction.

33. The device according to claim 27, wherein the middle part is expandable and a core setter is braceable in an axial direction relative to the expanded middle part.

34. The device according to claim 26, wherein the core fixing element is selectively expandable at a lower or a higher pressure.

35. The device according to claim 26, wherein the core damping element and the core fixing are positionable independently of each other.

36. The device according to claim 26, wherein the core fixing element is configured as an outer shoulder, the core fixing elements being movable by a lever into an expand or a collapse position to ensure, by forced guidance, a synchronous and centric bead fixing.

37. The device according to claim 27, further comprising center devices, wherein the drum halves and the center device are positionable for formation of a clearance.

38. The device according to claim 37, wherein the center devices are positionable without the drum halves in an expanded setting, the expanded setting being attainable by expansion of the core fixing elements of the two drum halves, wherein the core fixing elements of the drum halves are positioned under the outer sides of the middle parts.

39. The device according to claim 38, further comprising a center sleeve that covers the middle parts of the tire building drum, the center sleeve being of a material that is both axially and radially stretchable, wherein the middle parts have segmented fingers and the center sleeve is connected to an outer region of the segmented fingers.

40. The device according to claim 39, wherein the finger segments of the middle parts have a contour that forms pockets that enable reception of reinforcing strips.
